(19) United States
(12) Patent Application Publication
(10) Pub. No.: US 2008/0187720 A1
(43) Pub. Date: Aug. 7, 2008

(54) WAVE-SHAPED COATING STRUCTURE

(75) Inventor: Hyung Dae KIM, Beijing (CN)

Correspondence Address: SHERIDAN ROSS PC, 1560 BROADWAY, SUITE 1200, DENVER, CO, 80202, US

(73) Assignee: BEIJING BOE OPTOELECTRONICS TECHNOLOGY CO., LTD, Beijing (CN)

(21) Appl. No.: 11/956,041

(22) Filed: Dec. 13, 2007

(30) Foreign Application Priority Data
Feb. 6, 2007 (CN) 200710063601.7

(51) Int. Cl. B32B 3/30

(52) U.S. Cl. 428/167

(57) ABSTRACT

Provided is a wave-shaped coating structure comprising an S/R coating layer coated on TAB/COF. The S/R coating layer is provided with a plurality of recesses for making the edge of the layer to be wave-shaped. The width of the recess is 1-10 units of lead. The shape of the recess is rectangle, trapezoid, U-shape or V-shape.

### BACKGROUND OF THE INVENTION

The present invention relates to a TAB/COF structure used in LCD production, particularly to a wave-shaped S/R coating structure on TAB/COF.

In processing a driver chip integrated circuit 100′ (hereinafter is referred to as TAB/COF, wherein TAB refers to Tape Automated Bonding and COF refers to Chip On Film), as shown in FIG. 6, outer lead bonding (OLB) is normally employed. By OLB, the leads of COF are communicated with the leads of a panel in a longitudinal direction via conductive particles of anisotropic conductive film (hereinafter is referred to as ACF) in a certain density, but they are not communicated with each other in a transverse direction. An area 20′ where a printed circuit board (Bonding PCB) is bonded with TAB/COF 100 is located on an upper portion of TAB/COF 100′, while an area 30′ where a glass substrate (Bonding Cell) is bonded with TAB/COF 100 is located on an lower portion of TAB/COF 100′. Moreover, a solder resistance (S/R) is coated on TAB/COF to prevent the intrusion of foreign matter during bonding.

As shown in FIG. 6, the conventional shape of S/R coating layer 10′ is approximately rectangular, which has straight edges in the bonding area 30′, as shown in FIG. 7. The S/R coating structure with straight edges has some technical defects as follows:
(1) during bonding, if the S/R coating layer 10′ goes beyond the edges of panel 200′ and thereby the COF leads are exposed, the short circuit of COF leads may occur due to the intrusion of foreign matter P (particle), as shown in FIG. 8;
(2) if the S/R coating layer 10′ is adjusted close to the panel 200′ to prevent the intrusion of foreign matter, ACF particles may be deposited on the edges of S/R coating layer, which leads to short-circuit of the leads of TAB/COF 100, as shown in FIG. 9.

Generally, the width of a COF lead is a few decades of microns, and the diameter of an ACF conductive particle is a few microns. The above problems can be typically solved by adjusting the linear precision of the straight edges of S/R coating layer to ±0.1 mm. The advantage of such method is that it can be implemented simply and with low cost. However, it is difficult to improve linear precision of the straight edges considerably. Furthermore, the deposition of ACF particles cannot be prevented.

### SUMMARY OF THE INVENTION

The objective of present invention is to effectively solve the above-mentioned technical problems of the coating structure with straight SR edges, which has short-circuit problem between leads of TAB/COF due to the deposition of ACF particles on the edges of S/R coating layer, for example.

In order to achieve the above objective, the present invention provides a wave-shaped coating structure comprising a S/R coating layer coated on TAB/COF, wherein the S/R coating layer is provided with a plurality of recesses for making the edges of the layer to be wave-shaped.

The recesses are provided in the area of the S/R coating layer where a glass substrate is bonded with TAB/COF. The width of the recess is 1-10 units of lead, preferably 1-6 units of lead.

The shape of the recess may be rectangle, trapezoid, U-shape, V-shape.

The present invention describes a wave-shaped coating structure with a wave-shaped edge. By being provided with a plurality of recesses, the edge of the S/R coating layer forms a wave shape to prevent the intrusion of foreign matter. Meanwhile, in the area formed by the wave-shaped edge where no S/R coating layer is coated, a space is created where ACF particles can enter into when they are excluded during bonding to increase the space of the movement of the ACF particles, eliminate the deposition of the ACF particles, and finally avoid the short circuit of TAB/COF leads. Further, the present invention can reduce the defective rate due to the lead defect, and simplify the production-management.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the following detailed description.

### BRIEF DESCRIPTION OF THE DRAWINGS

The present invention will become more fully understood from the detailed description given hereinafter and the accompanying drawings which are given by way of illustration only, and thus are not limitative of the present invention and wherein:

FIG. 1 is a schematic view showing the wave-shaped coating structure according to the present invention;

FIG. 2 is a schematic view showing the recess of the S/R coating layer according to the present invention;

FIGS. 3a-3c is the schematic views showing the structure of trapezoid, U-shape or V-shape recess according to the present invention, respectively;

FIG. 4 is a schematic view showing the structure of the recess provided between the leads according to the present invention;

FIGS. 5a-5c is the schematic views showing the structure of U-shaped, trapezoidal or rectangular recess according to the present invention, respectively;

FIG. 6 is a schematic view showing the conventional S/R coating layer;

FIG. 7 is an enlarged detailed view of part A in FIG. 6; and

FIG. 8 and FIG. 9 are the schematic views showing a process of bonding.

### DETAILED DESCRIPTION OF THE PREFERRED EMBODIMENTS

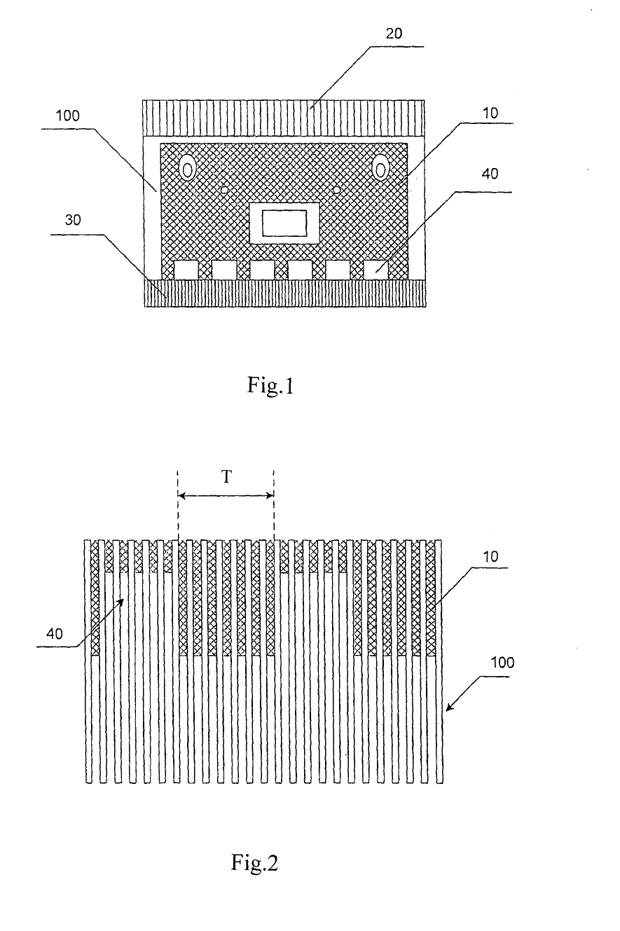

FIG. 1 is a schematic view showing the wave-shaped coating structure according to the present invention. As illustrated in FIG. 1, the S/R coating layer 10 is coated on TAB/COF 100, which presents rectangular shape as a whole. An area 20 where a printed circuit board (Bonding PCB) is bonded with TAB/COF 100 is located on an upper portion of TAB/COF 100, while an area 30 where a glass substrate (Bonding Cell) is bonded with TAB/COF 100 is located on a lower portion of TAB/COF 100. The distance between the leads in the bonding area 20 of TAB/COF 100 is relatively large, namely about hundreds of microns, which will not cause the deposition of ACF particle. The distance between the leads in the bonding area 30 of TAB/COF 100 is smaller, namely about tens of microns, which intends to cause the deposition of ACF particle to lead to the short circuit of leads of TAB/COF 100. According to the present invention, a plurality of recesses 40 is provided in the edge of the S/R coating layer 10 where a glass substrate is bonded with TAB/COF 100 so as to make the edge of the layer to be wave-shaped, thereby increasing the space of the movement of the ACF particles, eliminating the deposition of the ACF particle, and finally avoiding the short circuit of leads of TAB/COF.

FIG. 2 is a schematic view showing the recess of the S/R coating layer according to the present invention. The recess 40 of the present embodiment is rectangular, which is disposed on the edge of S/R coating layer in sequence so as to form a wave shape. In the area of the wave-shaped edge where no S/R coating layer is coated, a space is created where ACF particle can enter into if they are squeezed out during bonding, thereby the deposition of the ACF particle is reduced. The width T of the recess 40 is 1-10 units of lead, preferably 1-6 units of lead, so as to prevent the intrusion of foreign matter (Particle) during bonding. At the same time, the deposition of ACF particle is also reduced through providing the space for the movement of the ACF particles between the leads of TAB/COF via the recess 40. The unit of lead refers to the sum of the width of the lead of ACF particle and the distance between two leads.

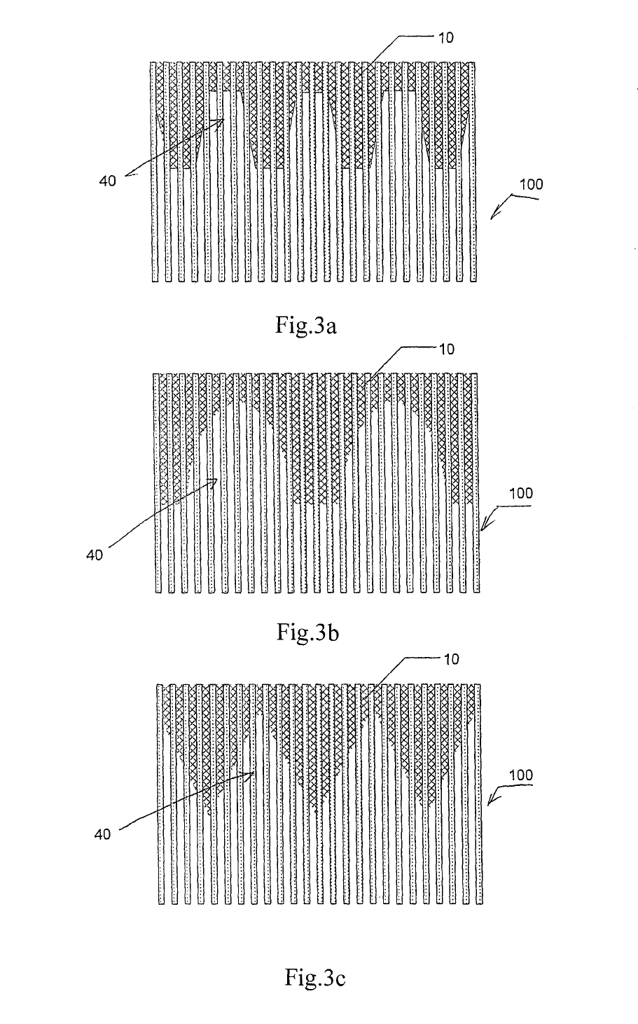

The shape of the recess can be embodied as trapezoid (as shown in FIG. 3a), U-shape (as shown in FIG. 3b), V-shape (as shown in FIG. 3c) or other shapes usually employed by those skilled in the art.

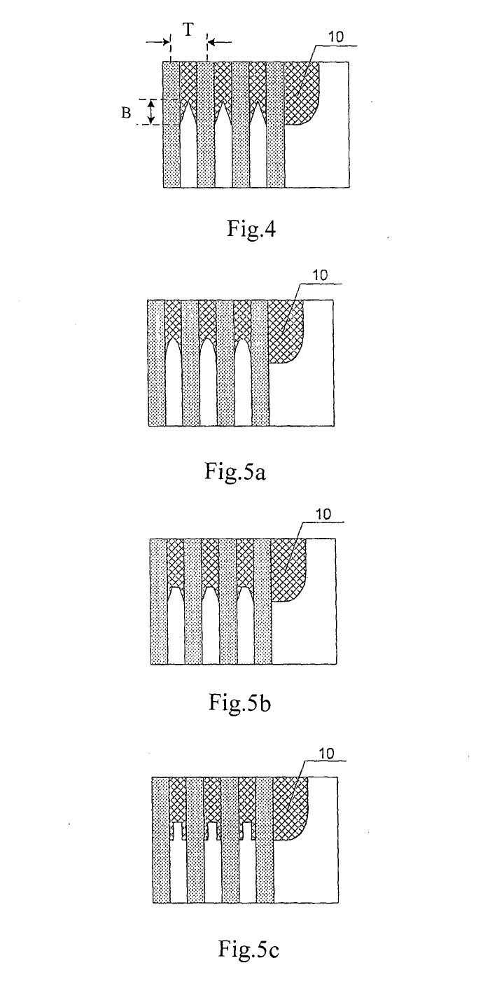

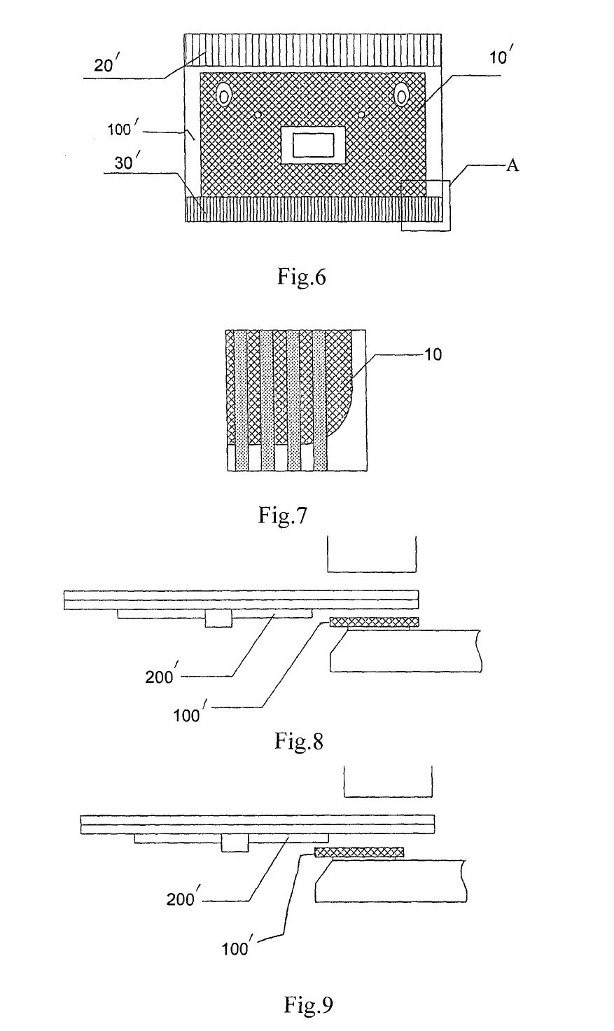

If the width of the recess is one unit of lead, the effect of the present invention to reduce the deposition of ACF particle via increasing the space of the movement of ACF particle is more distinct. FIG. 4 is a schematic view showing the structure of the recess provided between the leads according to the present invention. The recess 40 of the present embodiment is V-shaped, which is disposed on the edge of S/R coating layer in sequence so as to form a wave-shaped edge. In the area of the wave-shaped edge where no S/R coating layer is coated, a space is created where ACF particle can enter into when they are excluded during bonding, thereby to reduce the deposition of the ACF particle. The width T of the V-shape can be one unit of lead or equal to the distance between two leads. And the height B of the V-shape can be 200-300 μm. Thereby the intrusion of foreign matter during bonding is prevented. Meanwhile, because a space is provided between the leads of TAB/COF via the V-shape recess, the movement of the ACF particles is increased and thereby the deposition of ACF particles is reduced.

The shape of the recess may be U-shape (as shown in FIG. 5a), trapezoid (as shown in FIG. 5b), rectangle (as shown in 5c) or other shapes usually employed by those skilled in the art.

The invention being thus described, it will be obvious that the same may be varied in many ways. Such variations are not to be regarded as a departure from the spirit and scope of the invention, and all such modifications as would be obvious to those skilled in the art are intended to be included within the scope of the following claims.

What is claimed is:

1. A wave-shaped coating structure comprising an S/R coating layer coated on TAB/COF, wherein said S/R coating layer is provided with a plurality of recesses for making the edge of the layer to be wave-shaped.

2. The wave-shaped coating structure according to claim 1, wherein said recesses are provided in the area of said S/R coating layer where a glass substrate is bonded with TAB/COF.

3. The wave-shaped coating structure according to claim 1, wherein the width of said recess is 1-10 units of lead.

4. The wave-shaped coating structure according to claim 1, wherein the width of said recess is 1-6 units of lead.

5. The wave-shaped coating structure according to claim 1, wherein the width of said recess is one unit of lead.

6. The wave-shaped coating structure according to claims 1, wherein said recess has a rectangular shape.

7. The wave-shaped coating structure according to claims 1, wherein said recess has a trapezoid shape.

8. The wave-shaped coating structure according to claims 1, wherein said recess has a U-shape.

9. The wave-shaped coating structure according to claims 1, wherein said recess has a V-shape.
